(19) United States
(12) Patent Application Publication
(10) Pub. No.: US 2021/0381996 A1
(43) Pub. Date: Dec. 9, 2021

(54) CRACK SENSOR SYSTEM

(71) Applicant: MITSUBISHI HEAVY INDUSTRIES, LTD., Tokyo (JP)

(72) Inventor: Ryo YOSHINO, Tokyo (JP)

(21) Appl. No.: 17/410,081

(22) Filed: Aug. 24, 2021

Related U.S. Application Data
(63) Continuation of application No. PCT/JP2019/043592, filed on Nov. 7, 2019.

(30) Foreign Application Priority Data
Feb. 27, 2019 (JP) 2019-034786

(51) Int. Cl. G01N 27/20

(52) U.S. Cl. CPC G01N 27/20

(57) ABSTRACT

The present invention comprises: crack detection wiring (80) having a plurality of main element lines (A, B, C) in each of which one end is formed as a terminal (a, b, c) and in which the other ends are connected to each other, and an auxiliary element line (D) having a nearby element line portion (D1) that is provided in correspondence with at least one main element line (B) from among the plurality of main element lines (A, B, C) and that runs along the one main element line (B), and a distant element line portion (D2) that is connected to the nearby element line portion (D1) and that is more distant from the one main element line (B) than the nearby element line portion (D1); and a computation device (90) that performs a logic computation on the basis of the conduction state between a pair of terminals of the plurality of main element lines (A, B, C) and the conduction state of the auxiliary element line (D), thereby specifying the location of a disconnection in the main element lines (A, B, C).

### TECHNICAL FIELD

The present invention relates to a crack sensor system.

The present application claims priority based on Japanese Patent Application No. 2019-034786 filed in Japan on Feb. 27, 2019, and this application is a continuation application based on a PCT Patent Application No. PCT/JP2019/43592. The content of the PCT Application is incorporated herein by reference.

### BACKGROUND ART

It is known that members and devices made of metal or concrete become cracked (chapped) due to aging, wear, and unexpected heat or force. In a case where such cracks grow, there is a risk of the member breaking. Therefore, various techniques have been proposed that can immediately detect an occurrence of such cracks.

For example, the crack sensor and the crack monitoring device described in PTL 1 below include a common line and a plurality of gauge lead wires extending toward both sides in a direction intersecting the common line. The common line and the gauge lead wires are attached to the surface of the member to be monitored. If a crack occurs in the member in a region through which one gauge lead wire passes, the one gauge lead wire is disconnected. By detecting this disconnection, it is possible to recognize that a crack has occurred in the member at least in the region through which the one gauge lead wire passes.

Further, the crack sensor described in PTL 2 below is configured to detect a growth direction and growth rate of the crack by following the order of the gauge lead wires in which the disconnection occurs when the crack grows over the plurality of gauge lead wires (branch lines) described above.

### CITATION LIST

### Patent Literature

[PTL 1] Japanese Patent No. 6189344

[PTL 2] Japanese Patent No. 5971797

### SUMMARY OF INVENTION

### Technical Problem

However, although the crack sensors described in PTL 1 and PTL 2 can detect that a crack has occurred on the disconnected gauge lead wire, it is difficult to specify the exact position of the crack on the gauge lead wire. It is possible to increase the number of gauge lead wires, but this is not practical because the increase causes complicated wiring. For this reason, there is an increasing demand for a technique capable of specifying a crack occurrence location with higher accuracy without excessively increasing the number of wirings.

The present invention has been made to solve the above problems, and its object is to provide a crack sensor system capable of specifying a crack occurrence location with higher accuracy and evaluating the degree of crack elongation.

### Solution to Problem

A crack sensor system according to an aspect of the present invention includes: a crack detection wiring that has a plurality of main element lines, each of which is provided to extend along a wall surface and which respectively have one ends formed as terminals and the other ends connected to each other, and an auxiliary element line having a nearby element line portion which is provided in correspondence with at least one main element line among the plurality of main element lines and which is along the one main element line and a distant element line portion which is connected to the nearby element line portion and which is more distant from the one main element line than the nearby element line portion; and a calculation device that performs logic calculation on the basis of conduction states between pairs of terminals of the plurality of main element lines and a conduction state of the auxiliary element line so as to specify a location of a disconnection in the main element lines.

According to the above configuration, it is possible to specify which main element line is disconnected by performing a logic calculation via the calculation device based on the combination of the conduction states between the pair of terminals in the plurality of main element lines. That is, by specifying the disconnected main element line, the location where the crack occurs on the wall surface can be specified.

Further, in the above configuration, an auxiliary element line is provided corresponding to one main element line. The auxiliary element line has a nearby element line portion which is along the one main element line and a distant element line portion which is more distant from the one main element line than the one nearby element line portion. The calculation device performs a logic calculation in consideration of the conduction state of the auxiliary element lines in addition to the plurality of main element lines. For example, in a case where a crack occurs in a part of the wall surface through which the nearby element line portion passes, the nearby element line portion and the part which is along the nearby element line portion in one main element line are simultaneously disconnected. Therefore, in a case where a disconnection occurs in the nearby element line portion, it can be determined that a crack has occurred in the part of the main element line which is along the nearby element line portion.

On the other hand, in a case where no disconnection has occurred in the nearby element line portion, it can be determined that a crack has occurred in a part of the main element line different from the part which is along the nearby element line portion.

As described above, according to the above configuration, an auxiliary element line is provided in addition to the main element line, and a part of the auxiliary element line is provided along the main element line. Therefore, it is possible to easily specify a position of disconnection on the main element line, that is, a location where the crack occurs on the wall surface.

A crack sensor system according to an aspect of the present invention includes: a crack detection wiring that has a plurality of main element lines, each of which is provided to extend along a wall surface and which respectively have one ends formed as terminals and the other ends connected to each other, and an auxiliary element line which is provided in correspondence with at least one main element line among the plurality of main element lines, extends along the one main element line, and has a break strength different from a break strength of the one main element line; and a calculation device that performs logic calculation on the basis of conduction states between pairs of terminals of the plurality of main element lines and a conduction state of the auxiliary element line so as to specify a location of a disconnection in the main element lines.

According to the above configuration, the break strength of the auxiliary element line and the break strength of the main element line are different. Therefore, in a case where one crack occurs in the part through which the main element line and the auxiliary element line pass, either one of the main element line and the auxiliary element line is disconnected first.

For example, in a case where the break strength of the auxiliary element line is higher than the break strength of the main element line, the main element line is disconnected prior to the auxiliary element line. By detecting this, the occurrence of cracks can be recognized at an early stage where the scale thereof is small immediately after the occurrence.

In the crack sensor system, the main element line may have a break strength to such an extent that the main element line is disconnected at the same time when a crack occurs on the wall surface, and the auxiliary element line may have a higher break strength than the one main element line.

According to the above configuration, the main element line has a break strength to such an extent that the main element line is disconnected at the same time when the crack occurs. Therefore, in a case where one crack occurs in the part through which the main element line and the auxiliary element line pass, only the main element line is immediately disconnected at the same time as the occurrence.

In such a manner, by detecting a state in which only the main element line is disconnected and the auxiliary element line is not disconnected, cracks can be detected immediately at the same time as the occurrence.

Further, by detecting that the auxiliary element line is disconnected after the main element line is disconnected, it is possible to detect that the crack that has already occurred is further extended.

In the crack sensor system, the main element line may have a break strength to such an extent that the main element line is disconnected at the same time when a crack occurs on the wall surface, and the auxiliary element line may have a lower break strength than the main element line and also may have a break strength to such an extent that in a case where a shearing force is generated on the wall surface, the auxiliary element line is disconnected by the shearing force prior to the occurrence of the crack.

According to the above configuration, the auxiliary element line has a break strength to such an extent that the auxiliary element line is disconnected prior to the occurrence of the crack. Therefore, in a case where one crack occurs in the part where the main element line and the auxiliary element line pass, prior to the occurrence thereof, only the auxiliary element line is disconnected first due to the shearing force.

In such a manner, by detecting a state in which only the auxiliary element line is disconnected and the main element line is not disconnected, a sign of crack can be recognized prior to the occurrence.

Further, by detecting that the main element line is disconnected after the auxiliary element line is disconnected, it is possible to detect that a crack actually occurs in the part where the sign thereof is present.

In the crack sensor system, the auxiliary element line may have the nearby element line portion which is along at least one main element line among the plurality of main element lines, and the distant element line portion which is connected to the nearby element line portion and which is more distant from the one main element line than the nearby element line portion.

According to the above configuration, in a case where a crack occurs in a part of the wall surface through which the nearby element line portion passes, the nearby element line portion and the part which is along the nearby element line portion in one main element line are simultaneously disconnected.

Therefore, in a case where a disconnection occurs in the nearby element line portion, it can be determined that a crack has occurred in the part of the main element line which is along the nearby element line portion or that there is a sign of occurrence thereof.

On the other hand, in a case where no disconnection has occurred in the nearby element line portion, it can be determined that a crack has occurred in a part of the main element line different from the part which is along the nearby element line portion or that there is a sign of occurrence thereof.

As described above, according to the above configuration, an auxiliary element line is provided in addition to the main element line, and a part of the auxiliary element line is provided along the main element line. Therefore, it is possible to easily specify a position of disconnection on the main element line, that is, a location where the crack occurs on the wall surface.

### Advantageous Effects of Invention

According to the present invention, it is possible to provide a crack sensor system capable of specifying a crack occurrence location with higher accuracy.

### BRIEF DESCRIPTION OF DRAWINGS

FIG. 1 is a wiring diagram showing a configuration of a crack sensor system according to a first embodiment of the present invention.

FIG. 2 is a table showing an example of conduction states between terminals in the crack sensor system according to the first embodiment of the present invention.

FIG. 3 is an explanatory diagram showing a state of a wall surface corresponding to the table of FIG. 2.

FIG. 4 is a table showing another example of the conduction states between terminals in the crack sensor system according to the first embodiment of the present invention.

FIG. 5 is an explanatory diagram showing a state of a wall surface corresponding to the table of FIG. 4.

FIG. 6 is a wiring diagram showing a first modification example of the crack sensor system according to the first embodiment of the present invention.

FIG. 7 is a wiring diagram showing a second modification example of the crack sensor system according to the first embodiment of the present invention.

FIG. 8 is a wiring diagram showing a third modification example of the crack sensor system according to the first embodiment of the present invention.

FIG. 9 is a wiring diagram showing a configuration of a crack sensor system according to a second embodiment of the present invention.

FIG. 10 is a wiring diagram showing a configuration of a crack sensor system according to a third embodiment of the present invention.

FIG. 11 is a wiring diagram showing a further modification example of the crack sensor system according to the first embodiment of the present invention.

FIG. 12 is an example of a table showing time changes in the conduction states between terminals in the crack sensor system according to the first embodiment of the present invention.

FIG. 13 is another example of a table showing time changes in the conduction states between terminals in the crack sensor system according to the first embodiment of the present invention.

### DESCRIPTION OF EMBODIMENTS

### First Embodiment

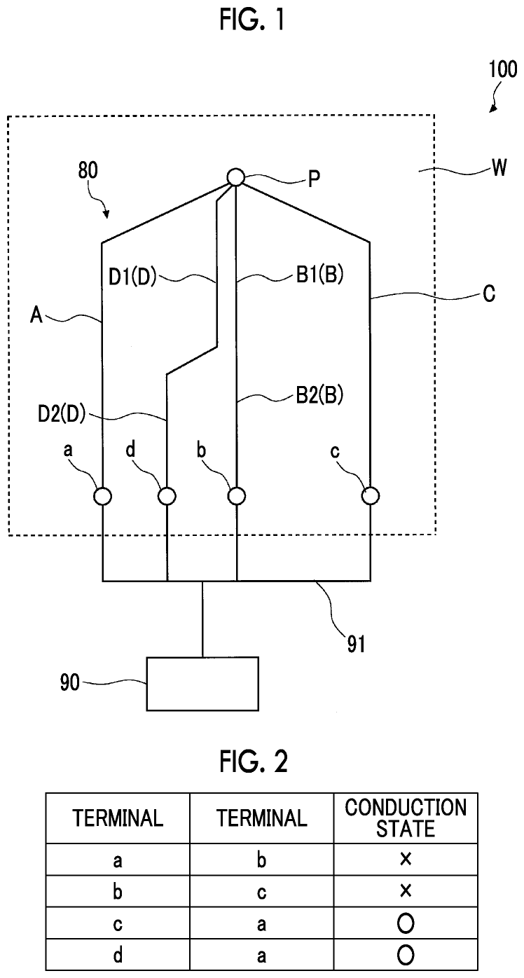

The first embodiment of the present invention will be described with reference to FIGS. 1 to 5. The crack sensor system according to the present embodiment is a device for detecting an occurrence of cracks (chaps) in a target member made of, for example, metal or concrete.

As shown in FIG. 1, the crack sensor system 100 includes a crack detection wiring 80 and a calculation device 90. The crack detection wiring 80 is disposed on a wall surface W of the target member. The calculation device 90 is electrically connected to the crack detection wiring 80, and specifies a presence or absence of cracks and their positions based on a conduction state of the crack detection wiring 80.

The crack detection wiring 80 has a plurality of (three) main element lines A, B, and C, and an auxiliary element line D. The main element lines A, B, and C are laid along the wall surface W at intervals from each other.

The main element lines A, B, and C are formed of an electrically conductive metallic material including, for example, copper and aluminum. Regardless of whether the wall surface W is a flat surface or a curved surface, the main element lines A, B, and C are laid to follow the shape of the wall surface W.

Further, in a case where a crack occurs on the wall surface W, a disconnection occurs immediately at a part of the main element lines A, B, and C that intersects the crack. In other words, the main element lines A, B, and C each have a tensile strength (break strength) to such an extent that the line is immediately disconnected in a case where a crack occurs.

Terminals a, b, and c are provided at one ends of the main element lines A, B, and C, respectively. Connection lines 91 extending from the calculation device described later are connected to the terminals a, b, and c. The other ends of the main element lines A, B, and C are connected to each other to form a node P. The terminals a, b, c, and the node P are also arranged on the wall surface W.

The terminals a, b, c, and the node P are arranged on the wall surface W at intervals from each other. Here, it is desirable that the terminals a, b, and c are arranged in a region on the wall surface W where cracks are unlikely to occur and that the node P is provided in a region on the wall surface W where cracks are expected to be particularly likely to occur. Further, it is desirable that the terminals a, b, and c are arranged at intervals from each other.

The auxiliary element line D extends along the main element line B among the above three main element lines A, B, and C. One end of the auxiliary element line D is a terminal d, and the other end is connected to the above-mentioned node P.

The auxiliary element line D extends from the node P and has a nearby element line portion D1, which is disposed relatively close to the main element line B, and a distant element line portion D2, which is connected to the nearby element line portion D1 and which is disposed so as to be relatively more distant from the main element line B than the nearby element line portion D1.

The nearby element line portion D1 extends in the same direction as the main element line B. The distant element line portion D2 is connected to one end side of the nearby element line portion D1 and extends in the same direction as the nearby element line portion D1 at a position distant from the main element line B.

The part of the main element line B along the nearby element line portion D1 is represented as a first part B1, and the part excluding the first part B1 (that is, the part corresponding to the distant element line portion D2) is represented as a second part B2. In a case where a crack occurs in the first part B1, the nearby element line portion D1 and the first part B1 are disconnected at the same time due to the crack.

In other words, the nearby element line portion D1 is close to the first part B1 (main element line B) to such an extent that the same crack causes a disconnection at the same time. The distant element line portion D2 and the main element line B are sufficiently distant from each other to such an extent that a single crack straddling the distant element line portion D2 and the main element line B does not occur.

Like the main element lines A, B, and C, the auxiliary element line D is also formed of an electrically conductive metallic material, including copper and aluminum. Regardless of whether the wall surface W is a flat surface or a curved surface, the auxiliary element line D is laid to follow the shape of the wall surface W. Further, in a case where a crack occurs on the wall surface W, a disconnection occurs immediately at a part of the auxiliary element line D that intersects the crack. In other words, like the main element lines A, B, and C, the auxiliary element line D has a tensile strength (break strength) to such an extent that the line is immediately disconnected in a case where a crack occurs.

In a case of laying the main element lines A, B, and C and the auxiliary element line D on the wall surface W, for example, a method of performing thermal spraying on a metallic material on the wall surface W may be used. Alternatively, a method of obtaining a desired wiring pattern by partially removing the metal film, which is laid-up on the wall surface W in advance by laser irradiation, may be used. Further, it is also possible to form these main element lines A, B, and C and the auxiliary element line D as a physical wiring by using a very thin wire.

Furthermore, it is also possible to use a method using a 3D printer such as additive manufacturing technology and AM technology.

The calculation device 90 is electrically connected to the terminals a, b, c, and d described above by the connection lines 91. The calculation device 90 performs a logic calculation based on the state of the current flowing through the crack detection wiring 80 (conduction state).

For example, in the state shown in FIG. 2, there is conduction between the terminal c and the terminal a and between the terminal d and the terminal a. That is, there is conduction between the main element line A and the main element line C and between the main element line A and the auxiliary element line D.

On the other hand, there is no conduction between the terminal a and the terminal b and between the terminal b and the terminal c. That is, there is no conduction between the main element line A and the main element line B and between the main element line B and the main element line C.

In the above state, from the input that “the terminal a and the terminal c are conducting, the terminal a and the terminal b are not conducting, and the terminal b and the terminal c are not conducting”, the calculation device 90 performs a logic calculation and determines that “a disconnection has occurred on the main element line B”.

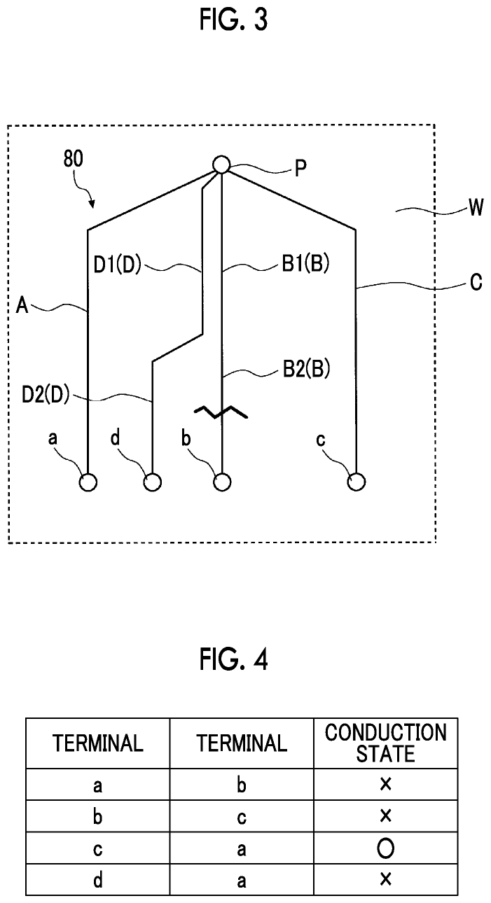

Further, since “the terminal d and the terminal a are conducting”, it is determined that “there is no disconnection on the auxiliary element line D”. As a result, the calculation device 90 determines that the location where the disconnection occurs is “a position which is on the main element line B and does not cause a disconnection in the auxiliary element line D”. That is, as shown in FIG. 3, the part where the disconnection occurs is specified as “the second part B2 in the main element line B”.

Further, in the state shown in FIG. 4, there is conduction between the terminal c and the terminal a. That is, the main element line A and the main element line C are conducting. On the other hand, there is no conduction between the terminal a and the terminal b, between the terminal b and the terminal c, and between the terminal d and the terminal a.

That is, there is no conduction between the main element line A and the main element line B, between the main element line B and the main element line C, and between the auxiliary element line D and the main element line A.

In this state, from the input that “the terminal a and the terminal c are conducting, the terminal a and the terminal b are not conducting, and the terminal b and the terminal c are not conducting”, the calculation device 90 performs a logic calculation and determines that “a disconnection has occurred on the main element line B”. Further, since “the terminal d and the terminal a are not conducting”, it is determined that “the auxiliary element line D and the main element line B are disconnected at the same time”.

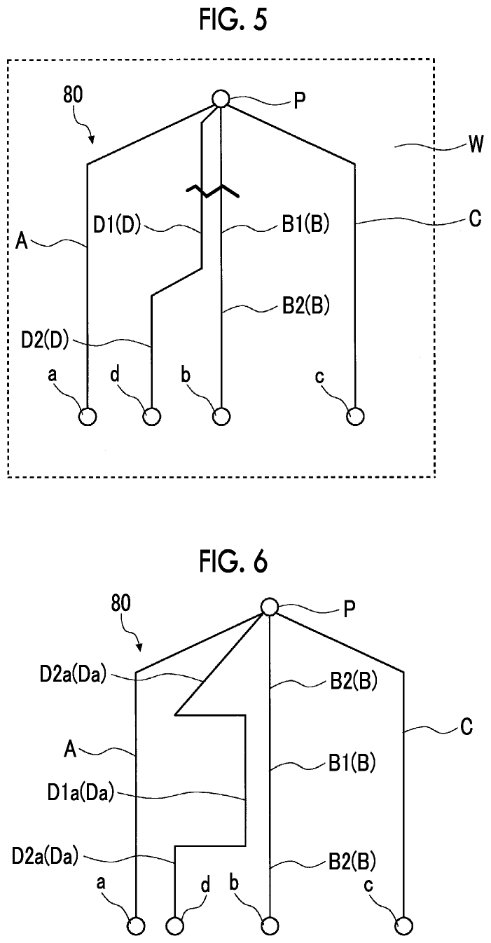

As a result, the calculation device 90 determines that the location where the disconnection occurs is “a position which is on the main element line B and causes a disconnection also in the auxiliary element line D”. As described above, the nearby element line portion D1 in the auxiliary element line D is close to the first part B1 in the main element line B. Therefore, as shown in FIG. 5, the location where the disconnection occurs is specified as “the first part B1 in the main element line B”.

According to the above configuration, the calculation device 90 performs a logic calculation based on the combination of the conduction states between the pair of terminals in the plurality of (three) main element lines A, B, and C. Therefore, it is possible to specify which of the main element lines A, B and C is disconnected.

That is, by specifying the disconnected main element line, the location where the crack occurs on the wall surface W can be specified. Further, in the above configuration, the auxiliary element line D is provided corresponding to one main element line B.

The auxiliary element line D has the nearby element line portion D1 which is along the main element line B and the distant element line portion D2 which is more distant from the main element line B than the nearby element line portion D1.

The calculation device 90 performs a logic calculation in consideration of the conduction state of the auxiliary element line D in addition to the main element lines A, B, and C. For example, in a case where a crack occurs in a part of the wall surface W through which the nearby element line portion D1 passes, the nearby element line portion D1 and the part (first part B1), which is along the nearby element line portion D1 in the main element line B, are simultaneously disconnected.

Therefore, in a case where there is a disconnection in the nearby element line portion D1, it can be determined that the crack occurs in the first part B1 in the main element line B.

On the other hand, if there is no disconnection in the nearby element line portion D1, it can be determined that a crack has occurred in a part (second part B2) different from the part which is along the nearby element line portion D1 in the main element line B.

As described above, according to the above configuration, the auxiliary element line D is provided in addition to the main element lines A, B, and C, and a part of the auxiliary element line D is provided along one main element line. Therefore, it is possible to easily specify a position of disconnection on the main element line, that is, a location where the crack occurs on the wall surface W, with high accuracy.

The first embodiment of the present invention has been described above. It should be noted that the above configuration can be changed and modified into various forms without departing from the scope of the present invention. For example, in the first embodiment, an example in which the nearby element line portion D1 in the auxiliary element line D extends from the node P has been described.

However, the mode of the auxiliary element line D is not limited to the above, and the configuration shown in FIG. 6 (first modification example) can be adopted. In the example of the drawing, a nearby element line portion D1a of an auxiliary element line Da is provided at an intermediate position from the node P to the terminal d. A pair of distant element line portions D2a are connected to both ends of the nearby element line portion D1a. With such a configuration, it is possible to specify the disconnection point on the main element line B in the same manner as described above.

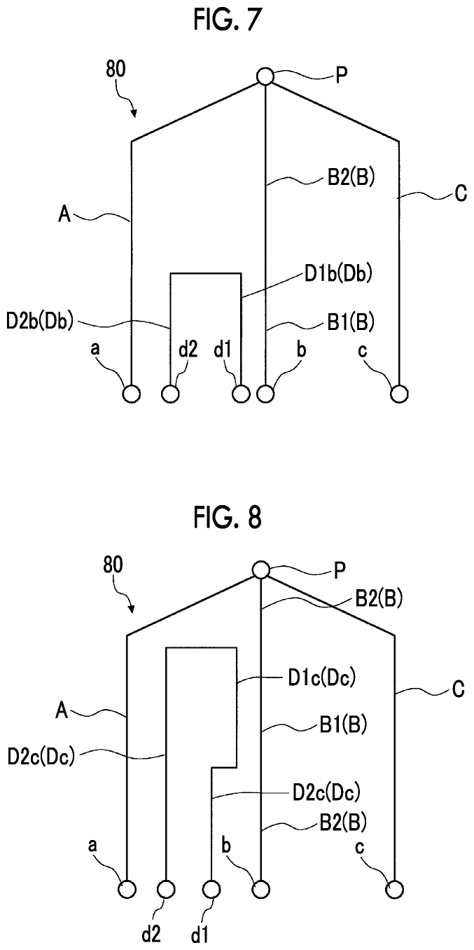

Further, as another example (second modification example), a configuration as shown in FIG. 7 can be adopted.

In the example of the drawing, terminals d1 and d2 are provided at both ends of an auxiliary element line Db. The auxiliary element line Db extends in a U shape from the terminal d1 to the terminal d2 between the main element line B and the main element line A.

In the auxiliary element line Db, the part close to the main element line B is referred to as a nearby element line portion D1b. Further, the terminal d1 and the terminal d2 are connected to the above-mentioned calculation device 90, respectively. With such a configuration, it is possible to specify the disconnection point on the main element line B in the same manner as described above.

As yet another example (third modification example), the configuration shown in FIG. 8 can be adopted.

In the example of the drawing, terminals d1 and terminals d2 are provided at both ends of an auxiliary element line Dc, as in the second modification example. The auxiliary element line Dc extends in a ring shape from the terminal d1 to the terminal d2 between the main element line B and the main element line A. In the auxiliary element line Dc, the part close to the main element line B is referred to as a nearby element line portion D1c.

In particular, in this modification example, the position of the nearby element line portion D1c is biased toward the node P side as compared with the second modification example. One end of the nearby element line portion D1c is directly connected to the terminal d1. Further, the terminal d1 and the terminal d2 are connected to the above-mentioned calculation device 90, respectively. With such a configuration, it is possible to specify the disconnection point on the main element line B in the same manner as described above.

Further, as a change common to the first embodiment, the first modification example, the second modification example, and the third modification example, the auxiliary element line D can also be provided in correspondence with the main element line A or C instead of the main element line B. Further, it is possible to combine a plurality of the crack detection wirings 80 described above. As a result, crack detection in a wider range can be realized.

### Second Embodiment

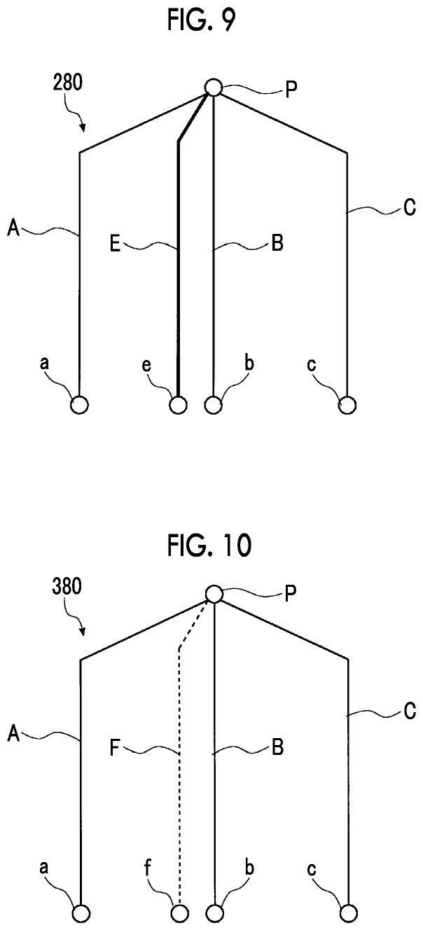

Subsequently, the second embodiment of the present invention will be described with reference to FIG. 9. The same components as those in the first embodiment are represented by the same reference numerals, and detailed description thereof will not be repeated.

In the present embodiment, a crack detection wiring 280 has the above-mentioned main element lines A, B, and C and the auxiliary element line E.

The auxiliary element line E extends along the main element line B among the main element lines A, B, and C. More specifically, the auxiliary element line E extends in the same direction at a position close to the main element line B. In other words, the auxiliary element line E is provided at the position close to the main element line B to such an extent that tensile stress is applied thereto due to an occurrence of a crack in a case where a single crack occurs in the region of the wall surface W through which the main element line B passes.

One end of the auxiliary element line E is a terminal e, and the other end is connected to the above-mentioned node P. The auxiliary element line E is formed of a material having a break strength different from that of the material forming the main element lines A, B, and C.

Specifically, the auxiliary element line E is formed of a metallic material having a higher tensile strength than the material forming the main element lines A, B, and C. On the other hand, the main element lines A, B, and C each have a tensile strength (break strength) to such an extent that in a case where a crack occurs on the wall surface W, there is a disconnection at the same time when the crack occurs.

According to the above configuration, the break strength of the auxiliary element line E and the break strength of the main element lines A, B, and C are different. Therefore, in a case where one crack occurs in the part through which the main element line B and the auxiliary element line E pass, either one of the main element line B and the auxiliary element line E is disconnected first.

For example, in a case where the break strength of the auxiliary element line E is higher than the break strength of the main element line B, the main element line B is disconnected prior to the auxiliary element line E. By detecting this, the occurrence of cracks can be recognized at an early stage where the scale thereof is small immediately after the occurrence.

Further, according to the above configuration, the main element line has a break strength to such an extent that the main element line B is disconnected at the same time when the crack occurs. Therefore, in a case where one crack occurs in the part through which the main element line B and the auxiliary element line E pass, only the main element line B is immediately disconnected at the same time as the occurrence.

In such a manner, by detecting a state in which only the main element line B is disconnected and the auxiliary element line E is not disconnected, cracks can be detected immediately at the same time as the occurrence. Further, by detecting that the auxiliary element line E is disconnected after the main element line B is disconnected, it is possible to detect that the crack that has already occurred is further extended.

The second embodiment of the present invention has been described above. It should be noted that the above configuration can be changed and modified into various forms without departing from the scope of the present invention. For example, in the second embodiment described above, a configuration for ensuring a difference in break strength by using different materials for the main element lines A, B, and C and the auxiliary element line E has been described.

However, in order to make the break strength different, it is also possible to adopt a configuration in which the diameter of the auxiliary element line E is set to be greater than the diameters of the main element lines A, B, and C while forming the main element lines A, B, and C and the auxiliary element line E with the same material.

It is also possible to provide the auxiliary element line E corresponding to the main element line A or C instead of the main element line B. Further, it is also possible to combine a plurality of the crack detection wirings 280 described above. As a result, crack detection in a wider range can be realized.

Further, it is also possible to adopt a configuration in which the auxiliary element line E has a nearby element line portion and a distant element line portion described in the first embodiment above.

### Third Embodiment

Next, the third embodiment of the present invention will be described with reference to FIG. 10. The same components as those in the above embodiments are represented by the same reference numerals, and detailed description thereof will not be repeated.

As shown in the drawing, in the present embodiment, a crack detection wiring 380 has the above-mentioned main element lines A, B, and C and auxiliary element line F. The auxiliary element line F extends along the main element line B among the main element lines A, B, and C.

More specifically, the auxiliary element line F extends in the same direction at a position close to the main element line B. In other words, in a case where a single crack is occurring in the region of the wall surface W through which the main element line B passes, the auxiliary element line F is provided at a position close to the main element line B to such an extent that the auxiliary element line F receives a shearing force (tensile stress) prior to the occurrence of the crack.

One end of the auxiliary element line F is a terminal f, and the other end is connected to the above-mentioned node P. The auxiliary element line F is formed of a material having a break strength different from that of the material forming the main element lines A, B, and C. Specifically, the auxiliary element line F is formed of a metallic material having a lower tensile strength (break strength) than the material forming the main element lines A, B, and C.

More specifically, the auxiliary element line F has a break strength to such an extent that in a case where a shearing force that causes a crack is generated on the wall surface W, there is a disconnection by the shearing force prior to the occurrence of the crack. On the other hand, the main element lines A, B, and C have a break strength to such an extent that in a case where a crack occurs on the wall surface W, there is a disconnection at the same time when the crack occurs.

According to the above configuration, the auxiliary element line has a break strength to such an extent that the auxiliary element line F is disconnected prior to the occurrence of the crack. Therefore, in a case where one crack occurs in the part where the main element line B and the auxiliary element line F pass, prior to the occurrence thereof, only the auxiliary element line F is disconnected first. In such a manner, by detecting a state in which only the auxiliary element line F is disconnected and the main element line B is not disconnected, a sign of crack can be recognized prior to the occurrence.

Further, by detecting that the main element line B is disconnected after the auxiliary element line F is disconnected, it is possible to detect that a crack actually occurs in the part where the sign thereof is present.

The third embodiment of the present invention has been described above.

It should be noted that the above configuration can be changed and modified into various forms without departing from the scope of the present invention. For example, in the third embodiment, the configuration for ensuring the difference in break strength by using different materials for the main element lines A, B, and C and the auxiliary element line F has been described.

However, in order to make the break strength different, it is also possible to adopt a configuration in which the diameter of the auxiliary element line F is set to be less than the diameters of the main element lines A, B, and C while forming the main element lines A, B, and C and the auxiliary element line F with the same material.

It is also possible to provide the auxiliary element line F corresponding to the main element line A or C instead of the main element line B. Further, it is also possible to combine a plurality of the crack detection wirings 380 described above. As a result, crack detection in a wider range can be realized.

Further, it is also possible to adopt a configuration in which the auxiliary element line F has the nearby element line portion D1 and the distant element line portion D2 described in the first embodiment above.

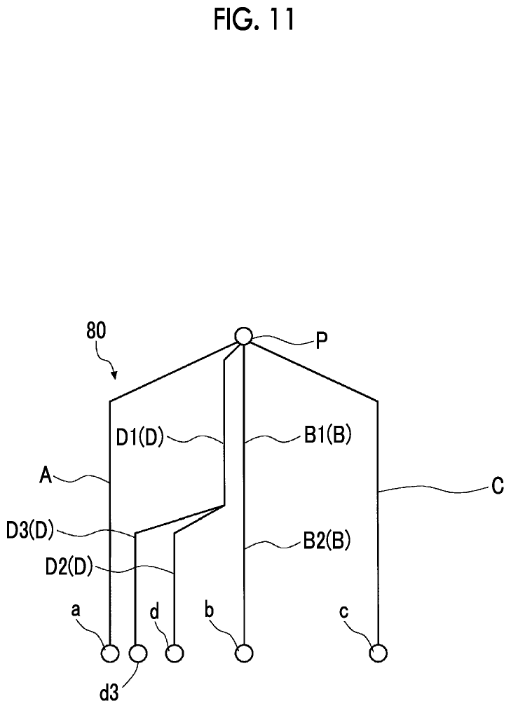

Further, in the above-described first embodiment, it is also possible to adopt a configuration in which another distant element line portion D3 is provided along the distant element line portion D2 (refer to FIG. 11). In this case, it can be determined that the first part B1 of the main element line portion B is disconnected based on the fact that the distant element line portions D2 and D3 are not disconnected.

That is, according to this configuration, the disconnection position on the main element line portion B can be specified more accurately.

In addition, it is also possible to adopt a configuration in which a time change is added to the determination of the conduction states of FIGS. 2 and 4 described in the first embodiment.

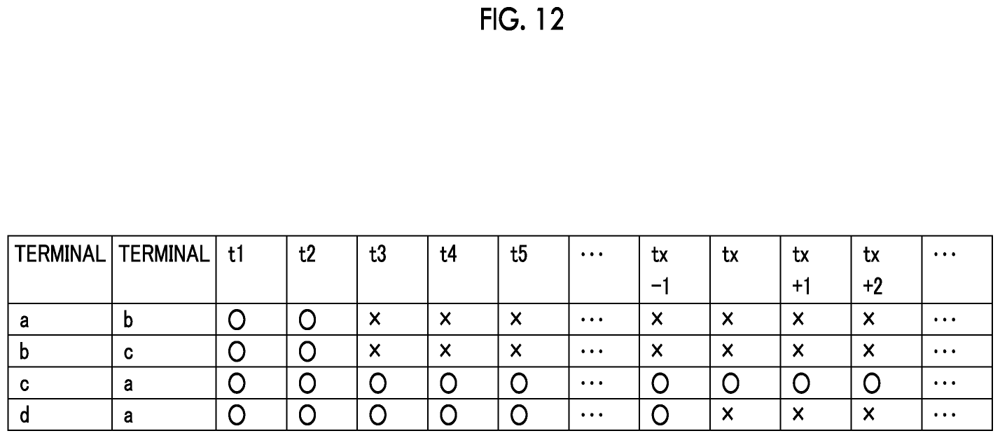

For example, as shown in FIG. 12, in a case where there is a time lag between disconnection timings of the main element line B and the auxiliary element line D, it can be determined that the second part B2 of the main element line B is disconnected at a time t3 and the auxiliary element line D is disconnected at a time tx.

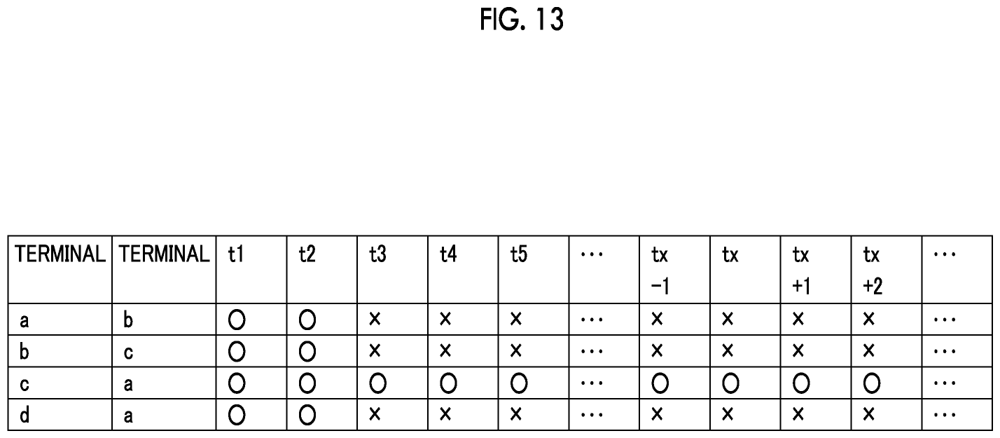

In the case of FIG. 12, it is difficult to specify which of the nearby element line portion D1 and the distant element line portion D2 is disconnected. However, in a case where the conduction state as shown in FIG. 13 is shown, the disconnection timings in the main element line B and the auxiliary element line D are the same. Therefore, it can be determined that the disconnection has occurred in the first part B1 of the main element line B and the nearby element line portion D1 at the time t3.

Although the preferred embodiments of the present invention have been described in detail above, the present invention is not limited to such specific embodiments and may be modified and changed into various forms within the scope of the present invention described in the claims.

### INDUSTRIAL APPLICABILITY

The present invention is applicable to crack sensor systems.

### REFERENCE SIGNS LIST

100: crack sensor system

80, 280, 380: crack detection wiring

90: calculation device

91: connection line

A, B, C: main element line

B1: first part

B2: second part

D, Da, Db, Dc, E, F: auxiliary element line

D1, D1a, D1b, D1c: nearby element line portion

D2, D2a, D2b, D2c, D3: distant element line portion

P: node

a, b, c, d, e, f, d1, d2, d3: terminal

1. A crack sensor system comprising:
a crack detection wiring that has a plurality of main element lines, each of which is provided to extend along a wall surface and which respectively have one ends formed as terminals and the other ends connected to each other, and an auxiliary element line having a nearby element line portion which is provided in correspondence with at least one main element line among the plurality of main element lines and which is along the one main element line and a distant element line portion which is connected to the nearby element line portion and which is more distant from the one main element line than the nearby element line portion; and
a calculation device that performs logic calculation on the basis of conduction states between pairs of terminals of the plurality of main element lines and a conduction state of the auxiliary element line so as to specify a location of a disconnection in the main element lines.

2. A crack sensor system comprising:
a crack detection wiring that has a plurality of main element lines, each of which is provided to extend along a wall surface and which respectively have one ends formed as terminals and the other ends connected to each other, and an auxiliary element line which is provided in correspondence with at least one main element line among the plurality of main element lines, extends along the one main element line, and has a break strength different from a break strength of the one main element line; and
a calculation device that performs logic calculation on the basis of conduction states between pairs of terminals of the plurality of main element lines and a conduction state of the auxiliary element line so as to specify a location of a disconnection in the main element lines.

3. The crack sensor system according to claim 2,
wherein the main element line has a break strength to such an extent that the main element line is disconnected at the same time when a crack occurs on the wall surface, and
the auxiliary element line has a higher break strength than the one main element line.

4. The crack sensor system according to claim 2,
wherein the main element line has a break strength to such an extent that the main element line is disconnected at the same time when a crack occurs on the wall surface, and
the auxiliary element line has a lower break strength than the main element line, and also has a break strength to such an extent that in a case where a shearing force is generated on the wall surface, the auxiliary element line is disconnected by the shearing force prior to the occurrence of the crack.

5. The crack sensor system according to claim 2, wherein the auxiliary element line has the nearby element line portion which is along at least one main element line among the plurality of main element lines, and the distant element line portion which is connected to the nearby element line portion and which is more distant from the one main element line than the nearby element line portion.

6. The crack sensor system according to claim 3, wherein the auxiliary element line has the nearby element line portion which is along at least one main element line among the plurality of main element lines, and the distant element line portion which is connected to the nearby element line portion and which is more distant from the one main element line than the nearby element line portion.

7. The crack sensor system according to claim 4, wherein the auxiliary element line has the nearby element line portion which is along at least one main element line among the plurality of main element lines, and the distant element line portion which is connected to the nearby element line portion and which is more distant from the one main element line than the nearby element line portion.
